(19) United States
(12) Patent Application Publication
(10) Pub. No.: US 2026/0331972 A1
(43) Pub. Date: Oct. 22, 2026

(54) ARMATURE DISPLACEMENT LIMITER

(71) Applicant: WOODWARD, INC., Fort Collins, CO (US)

(72) Inventors: Michael L. HAHN, Fort Collins, CO (US); Kevin M. ORLOSKE, Fort Collins, CO (US); Amy R. KIPPEN, Fort Collins, CO (US)

(21) Appl. No.: 19/109,745

(22) PCT Filed: Sep. 7, 2023
(86) PCT No.: PCT/US2023/032216

§ 371 Date: Mar. 7, 2025

Related U.S. Application Data
(60) Provisional application No. 63/374,994, filed on Sep. 8, 2022.

(51) Int. Cl. H02K 1/18; F16K 31/04; H02K 1/14; H02K 1/17; H02K 15/038; H02K 15/40; H02K 26/00

(52) U.S. Cl. CPC H02K 1/185; H02K 1/14; H02K 1/17; H02K 15/038; H02K 15/40; H02K 26/00; F16K 31/041; H02K 2213/09

(57) ABSTRACT

The subject matter of this specification can be embodied in, among other things, a torque motor that includes a base carrying an armature, said armature carrying an elongated body extending from a first elongate body end to a second elongate body end opposite the first elongate body end, and a displacement limiter having a bore at least partly defined therein and removably affixed to the base proximal the first elongate body end, wherein the first elongate body end at least partly extends into the bore.

### CLAIM OF PRIORITY

This application claims priority to U.S. Provisional Application No. 63/374,994, filed on Sep. 8, 2022, the contents of which are hereby incorporated by reference.

### TECHNICAL FIELD

This instant specification relates to electrical magnetic actuators and more specifically to torque motors which may be utilized in the pilot stages of electro-hydraulic or electro-pneumatic valves.

### BACKGROUND

Torque motors are well known in the prior art relating to electro-hydraulic servo-valves as well as to other types of valves used in the direct drive or pneumatic field. Typically, such torque motors are constructed from a pair of pole pieces, an armature, flexural or pivoting means to locate the armature within the torque motor structure, a pair of electromagnetic coils, a pair of magnets, and a motor housing. Such torque motors are useful in operating valves and controlling fluid flow of various types and may also be utilized in other applications as well.

In many of the applications involving torque motors, stability, and reliability of operation is critical. The ability to operate in extreme temperature cycling conditions of a repetitive nature is also critical, as is the resistance to vibration.

Various efforts have been exerted to provide torque motors having the desired reliability and stability and to obtain the operational characteristics as above described. Such techniques as filling spaces in between certain operational components of the torque motor with polymeric fillers, utilizing adhesive materials to retain parts in proper operational position and clamping components together utilizing various structures exerting inwardly directed compressive forces or the like have been utilized. Typical of such structures are those shown in prior art U.S. Pat. Nos. 5,473,298, 5,679,989, and 6,344,702. While such structures operate relatively well, they require a large number of parts and once assembled and placed into operation cannot be readily maintained or repaired without complete disassembly and in many instances are difficult to adjust at the time of manufacture to provide the required operational stability.

### SUMMARY

In general, this document describes electrical magnetic actuators and more specifically to torque motors which may be utilized in the pilot stages of electro-hydraulic or electro-pneumatic valves.

In a first example, a torque motor comprises a base carrying an armature, said armature carrying an elongated body extending from a first elongate body end to a second elongate body end opposite the first elongate body end, and a displacement limiter having a bore at least partly defined therein and removably affixed to the base proximal the first elongate body end, wherein the first elongate body end at least partly extends into the bore.

In a second example, according to example 1, the displacement limiter is configured as a plate.

In a third example, according to example 1 or 2, the bore at least partly coaxially surrounds the first elongate body end.

In a fourth example, according to any one of examples 1 to 3, the torque motor further comprises a predetermined gap defined within the bore between the displacement limiter and the first elongate body end.

In a fifth example, according to any one of examples 1 to 4, the torque motor is configured for use with a valve having a housing.

In a sixth example, according to any one of examples 1 to 5, the armature comprises a first armature end and second armature end and defines a first plurality of openings therein, and the displacement limiter defines a second plurality of openings therein, and the torque motor further comprises a lower pole piece defining a third plurality of openings therethrough, an upper pole piece defining a fourth plurality of openings therethrough, a first permanent magnet and a second permanent magnet disposed between said lower pole piece and said upper pole piece spacing them apart to define a first air gap and a second air gap between poles thereon within which said first armature end and said second armature end of said armature are disposed, each of said first permanent magnet and second permanent magnet defining a pair of grooves therein, said first, second, third, and fourth plurality of openings and said pair of grooves all being aligned, a first electromagnetic coil and a second electromagnetic coil positioned about said first armature end and said second armature end respectively, and a plurality of fasteners extending through said openings, slots, and grooves and being threadably received within predetermined threaded ones of said first plurality of openings for clamping said upper pole piece, lower pole piece, base, displacement limiter, first permanent magnet, and second permanent magnet together.

In a seventh example, according to example 6, said first electromagnetic coil and said second electromagnetic coil are carried by said lower pole piece.

In an eighth example, according to example 6 or 7, said first permanent magnet and said second permanent magnet are carried by said lower pole piece.

In a ninth example, a method of limiting displacement of an armature of a torque motor comprises at least partly surrounding a first elongate body end of an elongated body of the torque motor with a displacement limiter removably affixed to a housing of the torque motor, the displacement limiter having a bore at least partly defined therein and configured to receive the first elongate body end, wherein the elongated body extends from an armature of the torque motor at a second elongate body end opposite the first elongate body end to the first elongate body end, accelerating the torque motor, urging, by the accelerating, a movement of the first elongate body end relative to the displacement limiter, contacting the first elongate body end to the displacement limiter, and stopping, by the contacting, the movement of the first elongate body end.

In a tenth example, according to example 9, the method further comprises providing a base carrying the armature having first end and a second end and defining a first plurality of openings therethrough, providing a lower pole piece defining a second plurality of openings therethrough, providing a first electromagnetic coil and a second electromagnetic coil, providing a first permanent magnet and a second permanent magnet defining grooves therein, positioning said first electromagnetic coil and said second electromagnetic coil around said first end and said second end of said armature, positioning said first permanent magnet and said second permanent magnet on said lower pole piece, positioning an upper pole piece on said first permanent magnet and said second permanent magnets, the upper pole piece defining a third plurality of openings therethrough, positioning said displacement limiter on said upper pole piece, wherein said displacement limiter defines a fourth plurality of openings therein, aligning said grooves and slots with predetermined ones of said first, second, third, and fourth plurality of openings, providing a plurality of fasteners, inserting said plurality of fasteners through predetermined ones of said openings, said grooves, and said slots, and securing said plurality of fasteners to said base.

In an eleventh example, according to example 10, the method further comprises physically aligning said upper pole piece, said lower pole piece, said first permanent magnet, and said second permanent magnet to provide symmetry thereof on a base of the torque motor before the step of securing said plurality of fasteners.

In a twelfth example, according to example 11, the method further comprises testing said torque motor to ascertain a magnetic null thereof.

In a thirteenth example, according to example 11 or 12, the method further comprises providing armature adjusting screws and threadably positioning said armature adjusting screws in said upper pole piece to limit travel of said armature.

In a fourteenth example, according to any one of examples 11 to 13, the method further comprises charging at least one of said first permanent magnet and said second permanent magnet prior to positioning said first permanent magnet and said second permanent magnet on said lower pole piece.

In a fifteenth example, a torque motor armature displacement limiter comprises a body, and a bore at least partly defined in the body and configured to receive an end of an elongated body.

In a sixteenth example, according to example 15, the torque motor armature displacement limiter further comprises a first plurality of openings configured to align with a second plurality of openings defined in a torque motor and receive a plurality of fasteners therethrough such that the body is removably affixable to the torque motor.

In a seventeenth example, according to example 15 or 16, the body is configured as a substantially planar plate.

In an eighteenth example, according to any one of examples 15 to 17, the end of the elongated body received in the bore is substantially coaxially surrounded by the body.

In a nineteenth example, according to any one of examples 15 to 18, the torque motor armature displacement limiter further comprises a predetermined gap defined within the bore between the body and the end of the elongated body.

In an example embodiment, a torque motor includes a base carrying an armature, said armature carrying an elongated body extending from a first elongate body end to a second elongate body end opposite the first elongate body end, and a displacement limiter having a bore at least partly defined therein and removably affixed to the base proximal the first elongate body end, wherein the first elongate body end at least partly extends into the bore.

Various embodiments can include some, all, or none of the following features. The displacement limiter can be configured as a plate. The bore can at least partly coaxially surround the first elongate body end. The torque motor can include a predetermined gap defined within the bore between the displacement limiter and the first elongate body end. The torque motor can be configured for use with a valve having a housing. The armature can include a first armature end and second armature end and can define a first collection of openings therein, and the displacement limiter can define a second collection of openings therein, and the torque motor can include a lower pole piece defining a third collection of openings therethrough, an upper pole piece defining a fourth collection of openings therethrough, a first permanent magnet and a second permanent magnet disposed between said lower pole piece and said upper pole piece spacing them apart to define a first air gap and a second air gap between poles thereon within which said first armature end and said second armature end of said armature are disposed, each of said magnets defining a pair of grooves therein, a first electromagnetic coil and a second electromagnetic coil positioned about said first armature end and said second armature end respectively, said first, second, third, and fourth collection of openings and said grooves all being aligned, and a collection of fasteners extending through said openings, slots, and grooves and being threadably received within predetermined threaded ones of said first collection of openings for clamping said pole pieces, base, displacement limiter, and magnets together. Said first electromagnetic coil and said second electromagnetic coil can be carried by said lower pole piece. Said first permanent magnet and said second permanent magnet ca be carried by said lower pole piece.

In an example implementation, a method of limiting displacement of an armature of a torque motor includes at least partly surrounding a first elongate body end of an elongated body of the torque motor with a displacement limiter removably affixed to a housing of the torque motor, the displacement limiter having a bore at least partly defined therein and configured to receive the first elongate body end, wherein the elongated body extends from an armature of the torque motor at a second elongate body end opposite the first elongate end to the first elongate body end, accelerating the torque motor, urging, by the accelerating, a movement of the first elongate body end relative to the displacement limiter, contacting the first elongate body end to the displacement limiter, and stopping, by the contacting, the movement of the first elongate body end.

Various implementations can include some, all, or none of the following features. The method can include providing a base carrying the armature having first end and a second end and defining a first collection of openings therethrough, providing a lower pole piece defining a second collection of openings therethrough, providing a first electromagnetic coil and a second electromagnetic coil, providing a first permanent magnet and a second permanent magnet defining grooves therein, positioning said first electromagnetic coil and said second electromagnetic coil around said first end and said second end of said armature, positioning said first permanent magnet and said second permanent magnet on said lower pole piece, positioning an upper pole piece on said first permanent magnet and said second permanent magnets, the upper pole piece defining a third collection of openings therethrough, positioning said displacement limiter on said upper pole piece, wherein said displacement limiter defines a fourth collection of openings therein, aligning said grooves and slots with predetermined ones of said first, second, third, and fourth collection of openings, providing a collection of fasteners, inserting said collection of fasteners through predetermined ones of said openings, said grooves, and said slots, and securing said collection of fasteners to said base. The method can include physically aligning said upper pole piece, said lower pole piece, said first permanent magnet, and said second permanent magnet to provide symmetry thereof on a base of the torque motor before the step of securing said collection of fastener. The method can include testing said torque motor to ascertain a magnetic null thereof. The method can include providing armature adjusting screws and threadably positioning said armature adjusting screws in said upper pole piece to limit travel of said armature. The method can include charging at least one of said first permanent magnet and said second permanent magnet prior to positioning said first permanent magnet and said second permanent magnet on said lower pole piece.

In another example embodiment, a torque motor armature displacement limiter includes a body, and a bore at least partly defined in the body and configured to receive an end of an elongated body.

Various embodiments can include some, all, or none of the following features. The torque motor armature displacement limiter can include a first collection of openings configured to align with a second collection of openings defined in a torque motor and receive a collection of fasteners therethrough such that the body is removably affixable to the torque motor. The body can be configured as a substantially planar plate. The end of the elongated body received in the bore can be substantially coaxially surrounded by the body. The torque motor armature displacement limiter can include a predetermined gap defined within the bore between the body and the end of the elongated body.

The systems and techniques described here may provide one or more of the following advantages. First, a system can provide an electromagnetic actuator that is highly resistant to shock, vibration, and high accelerations. Second, the system can provide for assembly, configuration, and calibration before assembly of vibration-resistant components. Third, the vibration-resistant components can be easily integrated with little or no disassembly of the host electromagnetic actuator.

The details of one or more implementations are set forth in the accompanying drawings and the description below. Other features and advantages will be apparent from the description and drawings, and from the claims.

### DESCRIPTION OF DRAWINGS

FIG. 1 is an exploded view illustrating the various components of an example torque motor.

FIG. 2 is a front side view of the example torque motor of FIG. 1 shown in its assembled form.

FIG. 3 is a partial cross-sectional view of the assembled example torque motor of FIG. 2 taken about the lines 3-3 thereof.

FIG. 4 is a partial cross-sectional view of the example torque motor of FIG. 2 taken about the lines 4-4 thereof.

FIG. 5 is a cross-sectional view of an example torque motor constructed in accordance with the present disclosure assembled upon the housing of an example electro-hydraulic servo-valve.

FIG. 6 is a cross-sectional view of the example torque motor and valve of FIG. 5 taken about the lines 6-6 thereof.

FIG. 7 is an example front perspective view of the example armature assembly of the example torque motor of FIG. 1.

FIG. 8 is a partial perspective view of the example armature assembly and displacement limiter of the example torque motor of FIG. 1.

FIG. 9 is an enlarged partial cross-sectional view of the assembled example torque motor of FIG. 1.

FIG. 10 is an example front perspective view of the example torque motor of FIG. 1 in assembled form.

### DETAILED DESCRIPTION

This document describes systems and techniques for providing an electromagnetic actuator that is highly resistant to shock, vibration, and high accelerations. In this document, such electromagnetic actuators are described as torque motors, such as those used to operate servo valves. In general, the torque motor includes an armature that flexes under normal (e.g., electromechanical) operation. However, when exposed to mechanical shock forces, previous embodiments of such armatures can be caused to flex and possibly result in unwanted movement and/or output (e.g., unintended movement of a controlled servo valve). In general, this document describes the addition of a restraining plate that does not interfere with nominal operation of the armature, but can constrain armature displacement caused by high g-force shocks.

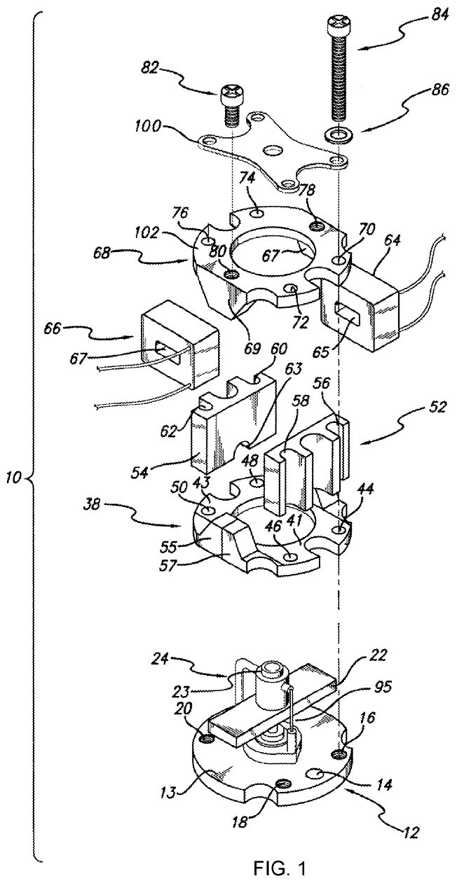

FIG. 1 is an exploded view illustrating the various components of a torque motor 10. As is therein shown, the torque motor 10 includes a base 12 which defines a plurality of openings 14, 16, 18, 20 and one additional opening (not shown) which is diametrically opposed to the opening 18 as well as an additional opening (not shown) diametrically opposed to the opening 14. The openings 16, 18, 20 and the one diametrically opposed to the opening 18 are threaded for the purpose of receiving a fastener as will be described more fully below. The base 12 carries an armature 22 which is a portion of an armature assembly 24 having an elongated body 23. In some embodiments, the armature assembly can include a jet pipe assembly. Jet pipe assemblies for use particularly in electro-hydraulic servo-valves are old and well known in the prior art. For example, those illustrated in U.S. Pat. Nos. 5,679,989, 5,473,298, and 6,344,702, above referred to and the disclosures thereof are incorporated herein by this reference. Therefore, more detailed description of a jet pipe assembly will not be provided herein since those skilled in the art will have adequate knowledge of the construction and function of such an assembly. Although an example of the armature assembly 24 is illustrated as a portion of the detailed illustrations and drawings in this application, it is to be expressly understood that the torque motor 10 may be utilized in other applications as well. Such for example, as a flapper-nozzle structure, direct drive valve, pneumatic valve, or the like.

A lower pole piece shown generally at 38. As is shown in FIG. 1, the lower pole piece 38 includes an open construction. Such construction provides easy assembly of the pole piece 38 upon the base 12 even after it is manufactured as a unit carrying the armature 22 and the armature assembly 24. It will be well understood by those skilled in the art that if the lower pole piece 38 is made as a single member, the pole piece would have to be assembled upon the base 12 prior to the assembly of the armature assembly 24 and the armature upon the base 12. Such would require a much more difficult and expensive assembly process and therefore the structure of the present disclosure having the lower pole piece formed of separate and distinct split apart sections simplifies the assembly and buildup of the torque motor.

A first permanent magnet 52 is carried by an upper surface 41 of the lower pole piece 38 while a second permanent magnet 54 is carried by the upper surface 43 of the lower pole piece 38. The permanent magnet 52 defines a pair of grooves 56 and 58 while the permanent magnet 54 defines a pair of grooves 60 and 62 and an opening 63. A similar opening (not shown) is provided in the permanent magnet 52. The grooves 56 through 62 are formed on the outer surfaces of the permanent magnets 52 and 54. The purpose of the grooves and the openings will become apparent from the description set forth below.

A pair of electromagnetic coils 64 and 66 are provided and are disposed so that the opposite ends of the armature 22 extend through the openings 65 and 67 provided in the electromagnetic coils 64 and 66, respectively. The lower surfaces of the electromagnetic coils 64 and 66 are also received upon the upper surfaces 41 and 43 of the lower pole piece 38.

An upper pole piece 68 defining a plurality of openings 70 through 80 is provided. The openings 78 and 80 are threaded to receive armature adjusting screws 82 (only one of which is illustrated). The armature adjusting screws extend through the upper poles 67 and 69 and extend therebelow by a small amount to control the amount of travel of the armature 22 in response to electrical signals applied to the electromagnetic coils 64 and 66. In some embodiments, such as in examples in which the armature assembly includes a nozzle-flapper assembly, adjustment screws may omitted and the amount of travel can be controlled by the nozzle.

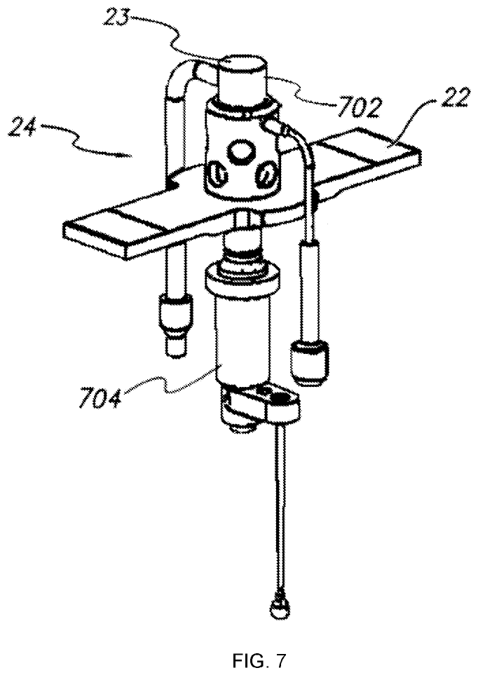

The elongated body 23 is pressed into the armature assembly 24. The elongated body 23 pivots about a center of rotation defined by the bending support beams and follows the movements of the armature 22 to control the direction of the fluid jet exiting from a jet. In some embodiments in which the armature assembly implements a nozzle-flapper design, torque can be generated about a pivot spring that can cause the armature to rotate, causing the flapper to close off the nozzle gap on one side and open it on the other side. As the elongated body 23 pivots, an elongate body end 702 (visible in FIG. 7) of the elongated body 23 moves slightly.

The torque motor 10 also includes a torque motor armature displacement limiter 100. The displacement limiter 100 has a body that is configured as a planar plate, and is assembled to an outer surface 102 (e.g., top surface, as the torque motor 10 is oriented in the illustrated example) of the upper pole piece 69. As will be discussed in more detail in the descriptions of FIGS. 6-8, the displacement limiter 100 is configured to be removably assembled to the torque motor 10 to limit lateral displacement of the elongated body 23 under shock-driven movements. In some embodiments, the outer surface 102 acts as part of a base that carries the armature 22.

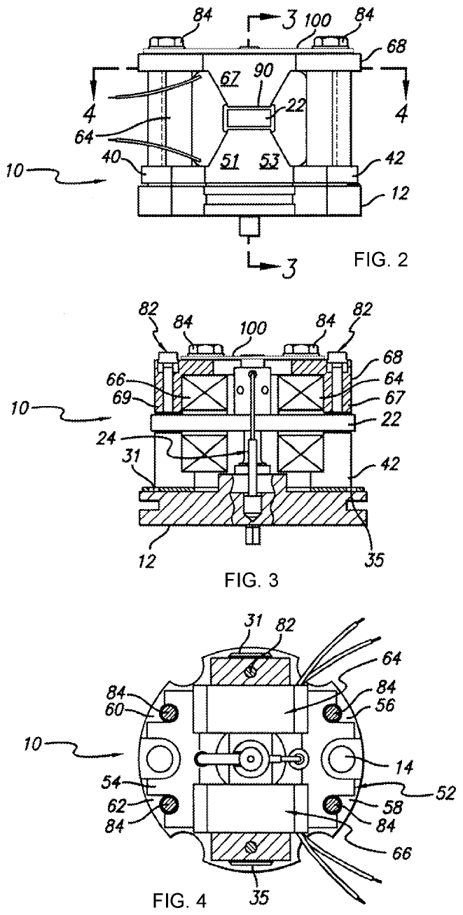

By reference now to FIGS. 2 through 4, there is illustrated in various views the torque motor as illustrated in FIG. 1 in exploded form in its assembled form. By reference particularly to FIG. 2, it is shown that the poles formed by the upper and lower pole pieces when brought together adjacent the armature 22 provide a working air gap such as illustrated at 90 formed by the pole 67 opposing the pole formed by the upwardly extending portions 51, 53 of the lower pole piece 38. As is well known to those skilled in the art, when an electrical signal is applied for example to the electromagnetic coils 64 and 66 the magnetic forces generated will cause the armature 22 to deflect within the air gap 90. Such deflection provides an appropriate output signal through functioning of the elongated body 23 as above described. As shown in FIG. 3, the adjusting screws 82 extend below the lower surfaces of the poles 67 and 69 so that the amount of deflection of the armature can be adjusted and controlled by extending the screws 82 further into the air gap 90 or retracting them further out of the air gap as the case may be.

By consideration of the illustrations shown in FIGS. 1 through 4, an example process of manufacturing the example torque motor 10 of FIG. 1 is provided. In the process of manufacturing, the magnetic electromagnetic coils 64 and 66 are first positioned upon the opposite ends of the armature 22. Thereafter, the lower pole piece 38 is inserted in position between the electromagnetic coils 64 and 66 and the upper surface 13 of the base 12. The permanent magnets 52 and 54 are then placed in position upon the upper surface 41 and the upper surface 43 of the lower pole piece 38. Subsequently, the upper pole piece 68 is positioned on top of the first and second magnets. In order to facilitate assembly of the parts as just described the permanent magnets 52 and 54 are pre-charged prior to the assembly operation. The permanent magnets 52 and 54 being pre-charged to assist in holding the various piece parts together as they are assembled one upon the other to form a base that carries the armature 22.

After the piece parts are thus assembled to define a base configured to carry the armature 22, the first and second shims are inserted between the upper surface 13 of the base 12 and the lower pole piece 38.

It should now be recognized that after the shims, upper and lower pole pieces, electromagnetic coils, and magnets are assembled upon the base carrying the armature assembly, the openings, slots, and grooves are properly aligned to receive the fasteners 84. For example, the opening 70 is aligned with the groove 56 which is aligned with the opening 44 which is aligned with the slot 36 which in turn is aligned with the threaded opening 16 in the base 12 to provide symmetry thereof. The fastener 84 with the washer 86 appropriately positioned with respect thereto is then inserted through the aligned openings, slots, and grooves and is threadably received within the threaded opening 16. A similar operation is accomplished at each of the other four corners thus aligning and positioning all of the parts operatively one with respect to the other. Appropriate spacing is then accomplished between the faces of the poles such for example at 69 and 55/67 (FIG. 1) to form the desired air gap 90 for operations according to the particular application involved. In some embodiments, shims may be inserted to obtain the desired spacing between the poles to provide the desired air gap, since the slots 30-36 can allow shims to be easily inserted into the structure. When such has been accomplished and the armature 22 is positioned properly to achieve magnetic null, the displacement limiter 100 is positioned on the outer surface 102 such that a bore 105 at least partly surrounds a portion of the elongated body 23 (e.g., laterally, coaxially), and the fasteners 84 are then securely engaged and locked in place on the base 12 thus completing the assembly of the torque motor. In the event that a minor adjustment is needed after appropriate testing, a tool may be inserted through the opening 63 in the magnet and the wire 95 of the armature assembly 24 may be slightly bent (e.g., as opposed to replacing a shim). In some embodiments, the bore 105 may extend off the way through the displacement limiter 100. In some embodiments, the bore 105 may be configured as a recess that partly extends into the interior of the displacement limiter 100.

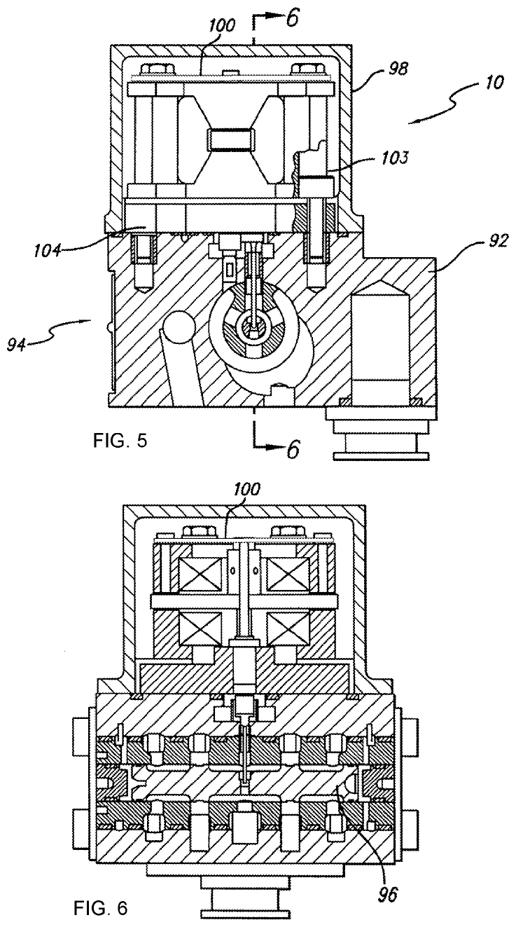

By reference now to FIGS. 5 and 6, the assembled torque motor 10 is shown positioned upon a housing 92 of the second stage 94 of an electro-hydraulic servo-valve which controls the flow of fluid from a source (not shown) to a load (not shown) by movement of an appropriate spool 96 reciprocally disposed within the housing 92. Again, this operation is well known to those skilled in the art and will not be more fully described herein. As is illustrated particularly in FIG. 5, appropriate fasteners 103 and 104 are used to secure the torque motor 10 to the housing 92 by passing through the opening 14 and the opening diametrically opposed to 14 on the base 12 (FIG. 4). An appropriate cover 98 is positioned over the torque motor 10 and secured in place on the housing 92 as is well known to those skilled in the art. It will also be appreciated by those skilled in the art that after the torque motor 10 is positioned upon the housing 92, it may be moved slightly in order to accomplish a matching of the hydraulic and magnetic nulls for the valves before tightening the fasteners 84.

FIG. 7 is an example front perspective view of the example armature assembly 24 of the example torque motor 10 of FIG. 1. The armature assembly 24 includes the armature 22 and the elongated body 23. The elongated body 23 is a cylindrical assembly that extends from the elongate body end 702 to a elongate body end 704 opposite the elongate body end 702.

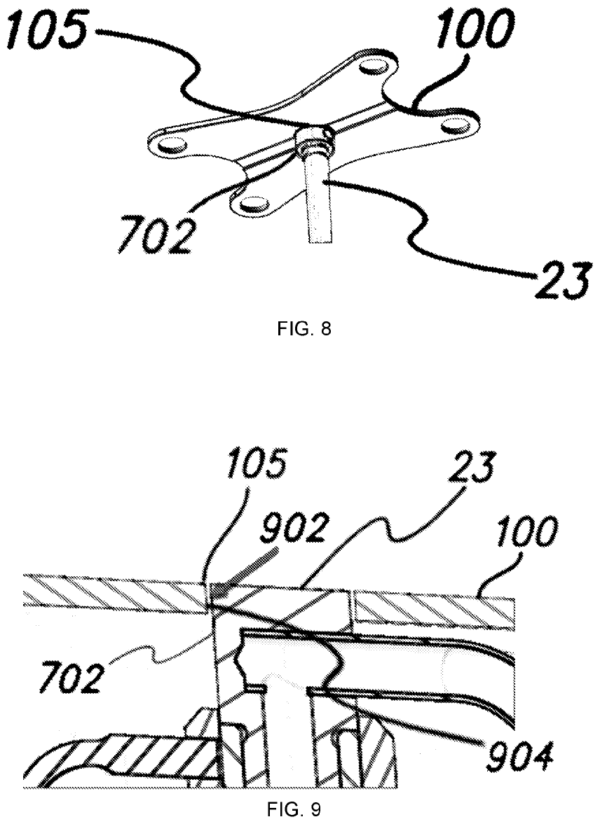

FIG. 8 is a partial perspective view of the example elongated body 23 and the displacement limiter 100 of the example torque motor 10 of FIG. 1. In the illustrated example, the elongate body end 702 is at least partly inserted into the bore 105 in the displacement limiter 100. As will be discussed in the description of FIG. 9, a gap exists between the elongate body end 702 and the surface of the displacement limiter that defines the bore 105.

FIG. 9 is an enlarged partial cross-sectional view of the assembled example torque motor 10 of FIG. 1. In the illustrated example, a predetermined gap 902 is visible in the bore 105, between the elongate body end 702 of the elongated body 23 and the displacement limiter 100. The bore 105 is defined by a circumferential face 904. During normal operation, the elongate body end 702 will pivot slightly as the armature 22 (not visible in this view) is urged to move by electrical current flowing through the electromagnetic coils 64 and 66. The bore 105 has a predefined diameter that is configured such that the predetermined gap 902 permits nominal movement of elongate body end 702. However, under other (e.g., abnormal, atypical) operations, such as when the torque motor 10 is subjected to external shock, vibration, or other accelerations, such accelerations can cause movement of the elongate body end 702. In the absence of the displacement limiter 100, such accelerations can urge movement of the elongate body end 702 beyond its designed or intended limits, and such movements can cause unintended output of the torque motor 10 (e.g., trigger unwanted operation of the example second stage 94 of FIG. 6) and/or damage to the armature assembly 22 (e.g., cracking or breakage of the elongated body 23). However, with the displacement limiter 100 in place, movements of the elongate body end 702 beyond the predetermined range of movement defined by the predetermined gap will cause the elongate body end 702 to contact the circumferential face 904 of the bore 105. With the elongate body end 702 in mechanical contact with the circumferential face 904, the displacement limiter 100 provides mechanical interference limiting displacement of the elongate body end 702 beyond the predetermined range of movement.

With the displacement limiter 100 in place, the predetermined gap 902 permits unimpeded movement of the elongate body end 702 within a predetermined range of movement, and prevents movements in excess of the predetermined range. Since the circumferential face 904 substantially circumferentially surrounds the elongate body end 702, the elongate body end 702 is protected from many forms and directions of accelerations (e.g., substantially all accelerations other than those directed linearly along or rotationally about the primary axis of the elongated body 23).

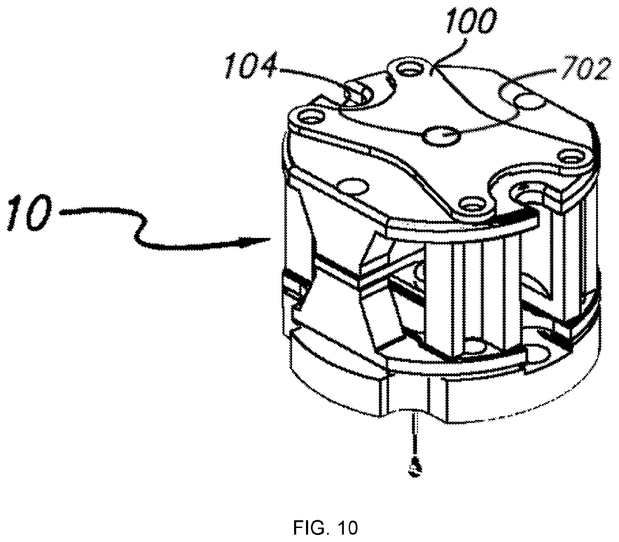

FIG. 10 is an example front perspective view of the example torque motor 10 of FIG. 1 in assembled form. As is visible in this example view, the example elongate body end 702 of the example elongated body 23 is show extending partly into the example bore 105 such that at least a portion of the elongate body end 702 is at least partly surrounded in a circumferential manner by the example displacement limiter 100.

It will be recognized by those skilled in the art that through the construction of the torque motor and its positioning upon the housing of an appropriate valve in accordance with the principles as above described, there is provided a torque motor having substantially less parts than torque motors of similar application in the past and provides a structure whereby maintenance of the torque motor can easily be accomplished without full disassembly thereof and if desired, disassembly is relatively easy to accomplish and the replacement of various component parts may be readily accomplished as compared to prior art torque motors.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A torque motor, said torque motor comprising:
a base carrying an armature, said armature carrying an elongated body extending from a first elongate body end to a second elongate body end opposite the first elongate body end; and
a displacement limiter having a bore at least partly defined therein and removably affixed to the base proximal the first elongate body end, wherein the first elongate body end at least partly extends into the bore.

2. The torque motor of claim 1, wherein the displacement limiter is configured as a plate.

3. The torque motor of claim 1, wherein the bore at least partly coaxially surrounds the first elongate body end.

4. The torque motor of claim 1, further comprising a predetermined gap defined within the bore between the displacement limiter and the first elongate body end.

5. The torque motor of claim 1, wherein the torque motor is configured for use with a valve having a housing.

6. The torque motor of claim 1, wherein:
the armature comprises a first armature end and a second armature end and defines a first plurality of openings therein; and
the displacement limiter defines a second plurality of openings therein; and
the torque motor further comprises:
a lower pole piece defining a third plurality of openings therethrough;
an upper pole piece defining a fourth plurality of openings therethrough;
a first permanent magnet and a second permanent magnet disposed between said lower pole piece and said upper pole piece spacing them apart to define a first air gap and a second air gap between poles thereon within which said first armature end and said second armature end of said armature are disposed, each of said first permanent magnet and second permanent magnet defining a pair of grooves therein, said first, second, third, and fourth plurality of openings and said pair of grooves all being aligned;
a first electromagnetic coil and a second electromagnetic coil positioned about said first armature end and said second armature end respectively; and
a plurality of fasteners extending through said openings, slots, and grooves and being threadably received within predetermined threaded ones of said first plurality of openings for clamping said upper pole piece, lower pole piece, base, displacement limiter, first permanent magnet, and second permanent magnet together.

7. The torque motor of claim 6, wherein said first electromagnetic coil and said second electromagnetic coil are carried by said lower pole piece.

8. The torque motor of claim 6, wherein said first permanent magnet and said second permanent magnet are carried by said lower pole piece.

9. A method of limiting displacement of an armature of a torque motor, the method comprising:
at least partly surrounding a first elongate body end of an elongated body of the torque motor with a displacement limiter removably affixed to a housing of the torque motor, the displacement limiter having a bore at least partly defined therein and configured to receive the first elongate body end, wherein the elongated body extends from an armature of the torque motor at a second elongate body end opposite the first elongate body end to the first elongate body end;
accelerating the torque motor;
urging, by the accelerating, a movement of the first elongate body end relative to the displacement limiter;
contacting the first elongate body end to the displacement limiter; and
stopping, by the contacting, the movement of the first elongate body end.

10. The method of claim 9, further comprising:
providing a base carrying the armature having first end and a second end and defining a first plurality of openings therethrough;
providing a lower pole piece defining a second plurality of openings therethrough;
providing a first electromagnetic coil and a second electromagnetic coil;
providing a first permanent magnet and a second permanent magnet defining grooves therein;
positioning said first electromagnetic coil and said second electromagnetic coil around said first end and said second end of said armature;
positioning said first permanent magnet and said second permanent magnet on said lower pole piece;
positioning an upper pole piece on said first permanent magnet and said second permanent magnets, the upper pole piece defining a third plurality of openings therethrough;
positioning said displacement limiter on said upper pole piece, wherein said displacement limiter defines a fourth plurality of openings therein;
aligning said grooves and slots with predetermined ones of said first, second, third, and fourth plurality of openings;
providing a plurality of fasteners;
inserting said plurality of fasteners through predetermined ones of said openings, said grooves, and said slots; and
securing said plurality of fasteners to said base.

11. The method of claim 10, further comprising physically aligning said upper pole piece, said lower pole piece, said first permanent magnet, and said second permanent magnet to provide symmetry thereof on a base of the torque motor before the step of securing said plurality of fasteners.

12. The method of claim 11, further comprising testing said torque motor to ascertain a magnetic null thereof.

13. The method of claim 11, further comprising providing armature adjusting screws and threadably positioning said armature adjusting screws in said upper pole piece to limit travel of said armature.

14. The method of claim 11, further comprising charging at least one of said first permanent magnet and said second permanent magnet prior to positioning said first permanent magnet and said second permanent magnet on said lower pole piece.

15. A torque motor armature displacement limiter comprising:
a body; and
a bore at least partly defined in the body and configured to receive an end of an elongated body.

16. The torque motor armature displacement limiter of claim 15, further comprising a first plurality of openings configured to align with a second plurality of openings defined in a torque motor and receive a plurality of fasteners therethrough such that the body is removably affixable to the torque motor.

17. The torque motor armature displacement limiter of claim 15, wherein the body is configured as a substantially planar plate.

18. The torque motor armature displacement limiter of claim 15, wherein the end of the elongated body received in the bore is substantially coaxially surrounded by the body.

19. The torque motor armature displacement limiter of claim 15, further comprising a predetermined gap defined within the bore between the body and the end of the elongated body.
